(19) United States
(12) Patent Application Publication
(10) Pub. No.: US 2009/0271306 A1
(43) Pub. Date: Oct. 29, 2009

(54) System and Method to Facilitate Secure Payment of Digital Transactions

(75) Inventor: Gregory J. Pierson, Woodland, WA (US)

Correspondence Address: Davis Wright Tremaine LLP - Portland;William A. Birdwell, 1300 S.W. Fifth Avenue, SUITE 2300, Portland, OR, 97201-5630, US

(73) Assignee: Iovation Inc., Portland, OR (US)

(21) Appl. No.: 12/432,714

(22) Filed: Apr. 29, 2009

Related U.S. Application Data
(60) Provisional application No. 61/048,887, filed on Apr. 29, 2008.

(51) Int. Cl. G06Q 40/00

(52) U.S. Cl. 705/35

(57) ABSTRACT

System and method for facilitating verification that an authorized user of an account initiated use of the account in a digital transaction online are described herein. A preferred embodiment employs an application supplied by a third party to associate the account with a client device that is, in turn, associated with the authorized user.

### CROSS-REFERENCE TO RELATED APPLICATION

The present application claims benefit of provisional U.S. Patent Application No. 61/048,887, filed Apr. 29, 2008.

### TECHNICAL FIELD

Embodiments of the present invention relate to the field of data processing, and more particularly, to systems and methods to facilitate secure payment in digital transactions via various verification techniques.

### BACKGROUND

Advances in integrated circuit, microprocessor and related technologies have led to the proliferation of a wide variety of computing devices having a wide range of computing capabilities. At the same time, advances in telecommunication, networking and other related technologies have the led to the proliferation of networked computing. Today, users of a variety of client computing devices may access a wide variety of online services including, for example, obtaining data, merchandising, and multimedia (e.g., music and video) informational and entertainment services.

Many online services require payment for various reasons, such as compensation for merchandise, services, or maintaining data security and privacy. Among the primary methods of payment for online services are credit cards, debit cards, and pre-loaded spending cards such as gift cards. Hereinafter, these methods of payment will be collectively referred to as “payment cards.” It is important to ensure that a user of such a payment card is authorized. Known approaches for routine payment authorization include requiring entry of “authentication digits” printed in a designated location on the payment card. This practice helps to guard against theft of some payment card numbers, but not of the cards themselves. Further verification methods typically require the intervention of intermediate financial processors.

### BRIEF DESCRIPTION OF THE DRAWINGS

The present invention will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 is a schematic of a computer system, suitable for use in practicing selected aspects of the present invention, in accordance with a preferred embodiment.

FIG. 2 is a schematic of a payment network, incorporated with the teachings of the present invention, in accordance with a preferred embodiment.

### DETAILED DESCRIPTION OF EMBODIMENTS OF THE INVENTION

Embodiments of the present invention include, but are not limited to, methods and apparatuses, including computer and network systems, to facilitate secure payment in digital transactions associated with a payment card or an account in online transactions by verifying that a digital transaction is being performed by an authorized user of the payment card or the account. For example, in some embodiments, the payment card is pre-associated with one or more client devices. Typically, an authorized customer will use the payment card while transacting business over the network such as the Internet (“online”), from an associated client device.

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

For the purposes of the present invention, the phrase “A/B” means A or B. For the purposes of the present invention, the phrase “A or B” means “(A), (B), or (A and B)”. For the purposes of the present invention, the phrase “at least one of A, B, and C” means “(A), (B), (C), (A and B), (A and C), (B and C), or (A, B and C)”. For the purposes of the present invention, the phrase “(A)B” means “(B) or (AB)” that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

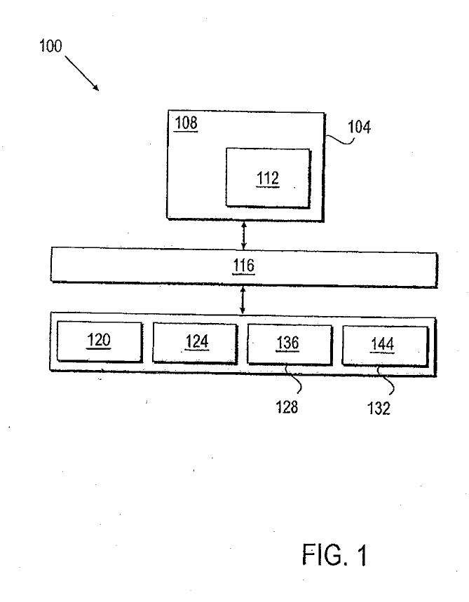

FIG. 1 schematically illustrates an example of a computer system 100 that may operate as a server, a client device, a database, etc., in accordance with a preferred embodiment of the present invention. The system 100 may have an execution environment 104, which may be a domain of an executing operating system (OS) 108. The OS 108 may be a component configured to execute and to control general operation of other components within the execution environment 104, such as a software component 112, subject to management by a management module 116. The management module 116 may arbitrate general component access to hardware resources such as one or more processor(s) 120, a network interface controller 124, storage 128, or memory 132.

The software component 112 may be a supervisory-level component, for example, a kernel. In various embodiments, a kernel component may be a service such as a loader, scheduler, or memory manager; or an extension/driver for a network card, a universal serial bus (USB) interface, or a disk drive; or a service-driver hybrid such as an intrusion detector to watch execution of code.

One or more processors 120 may execute programming instructions of components of the system 100. A given processor 120 may be a single or multiple-core processor, controller, application specific integrated circuit (ASIC), or other suitable device.

Storage 128 may represent non-volatile storage of persistent content to be used for the execution of the components of the system 100, such as, but not limited to, operating systems, program files, configuration files, etc. Storage 128 may include stored content 136, which may represent the persistent store of source content for the component 112. The persistent store of source content may include, for example, executable code, files, or code segments, links to other routines such as a call to a dynamic linked library (DLL), and data segments, or other suitable software components. Storage 128 may include integrated or peripheral storage devices, such as, but not limited to, disks and associated magnetic, optical, or other types of disk drives, universal serial bus (USB) storage devices and associated ports, flash memory, read-only memory (ROM), and other non-volatile semiconductor memory devices. Storage 128 may be physically part of the system 100 or in alternative embodiments. Storage 128 may be accessible by, but not necessarily a physical part of, the system 100. For example, storage 128 may be accessed by the system 100 over a network via the network interface controller 124. Additionally, multiple systems 100 may be operatively coupled to one another via one or more networks.

Upon a load request, e.g., from a loading agent of the OS 108, the management module 116 or the OS 108 may load the stored content 136 from storage 128 into memory 132 as active content 144 for operation of the component 112 in the execution environment 104.

The memory 132 may be volatile storage to provide active content for operation of components on the system 100. Memory 132 may include random access memory (RAM), dynamic RAM (DRAM), static RAM (SRAM), synchronous DRAM (SDRAM), dual-data rate RAM (DDRRAM), etc. The memory 132 may organize content stored therein into a number of groups of memory locations. These organizational groups, which have a fixed or a variable size, may facilitate virtual memory management. The groups of memory locations may be pages, segments, or a combination thereof.

As used herein, the term “component” is intended to refer to programming logic and associated data that may be employed to obtain a desired outcome. The term component may be synonymous with “module” or “agent” and may refer to programming logic embodied in hardware or firmware, or in a collection of software instructions, possibly having entry and exit points, and written in a programming language, such as, for example, C++, Intel Architecture 32-bit (IA-32) executable code, or other suitable languages.

A software component may be compiled and linked into an executable program, or installed in a dynamic link library, or it may be written in an interpretive language such as BASIC. It will be appreciated that software components may be invoked by other components or by themselves, or in response to detected events or interrupts. Software instructions may be provided in a machine accessible medium which, when accessed, may result in a machine performing operations or executions described in conjunction with components of embodiments of the present invention. A machine accessible medium may be firmware, such as an electrically erasable programmable read-only memory (EEPROM), or other recordable or non-recordable medium, such as ROM, RAM, magnetic disk storage, optical disk storage, or other suitable memory media. It will be further appreciated that hardware components may comprise connected logic units, such as gates and flip-flops, or programmable units, such as programmable gate arrays or processors. In some embodiments, the components described herein are implemented as software modules, but nonetheless may be represented in hardware or firmware. Furthermore, although only a given number of discrete software and hardware components may be illustrated or described, such components may nonetheless be represented by additional components or fewer components without departing from the spirit and scope of embodiments of the invention.

An article of manufacture, according to the present invention, may be employed to facilitate implementation of one or more methods as disclosed herein. According to a preferred embodiment, an article of manufacture comprises a plurality of programming instructions saved in a storage medium, and adapted to program an apparatus to enable the apparatus to request from a proxy server a location restriction to modify a set of user preferences. Programming instructions may be adapted to modify one or more user preferences to subject them to one or more location restrictions. Furthermore, articles of manufacture may be employed to implement one or more methods disclosed herein in one or more client devices. Programming instructions may be adapted to implement a browser, that in turn may be adapted to allow a user to display information related to accessing a network. Alternatively, programming instructions may be adapted to implement a browser on a client device.

Examples of computer system 100 in the form of a client device include, but are not limited to, a desktop computer, a laptop computer, a handheld computer, a tablet computer, a cellular telephone, a personal digital assistant (PDA), an audio or video player such as an MP3 player or a DVD player, a gaming device, a navigation device such as a GPS device) or other suitable fixed, portable, or mobile electronic devices. Alternatively, the functions described herein may be distributed among a plurality of computer systems instead.

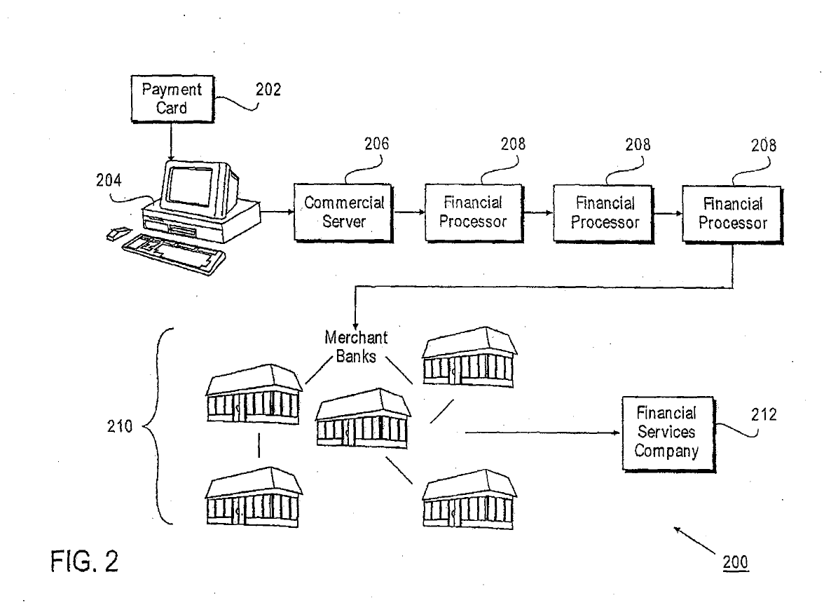

With reference to FIG. 2, an exemplary payment network 200 is schematically illustrated. The network 200 may include multiple computing systems 100 or parts thereof in the form of servers, client devices, databases, or other computer systems or devices. The network 200 is generally electronically and communicatively coupled via a network such as, for example, the Internet. The exemplary network 200 as illustrated includes a payment card 202, a client device 204, a commercial server 206 representing a website that provides goods or services via online transactions, multiple financial processors 208, multiple merchant banks 210, and a financial services company 212. Examples of financial services company 212 include credit card companies (e.g., Visa, MasterCard, American Express), investment companies, and insurance companies. Network 200 is merely an example and those skilled in the art will understand that more or fewer of each type of component illustrated may be included. Additionally, various types of components may be added or eliminated.

A web site, as used herein, is generally a collection of hyperlinked web page images, videos and other digital assets that is hosted on one or several web servers, usually accessible via the Internet, a cell phone, or a local access network (LAN). A web page is a document typically written in Hypertext Markup Language (HTML) that is almost always accessible via HTTP or HTTPS, which are transfer protocols that transfer information from the web server to display in the user's web browser.

In accordance with the present invention, an account, such as, for example, a credit card or a debit card account that may be licensed by financial services company 212 and issued through one of the merchant banks 210, may be associated with payment card 202. As is known in the art, the payment card 202 is generally associated with one or more authorized users and represents an account such as a credit account, debit account, bank account or an investment account. Likewise, an account may also generally be associated with one or more authorized users, whether or not the account is associated with payment card 202.

In general, as is known in the art, when a digital transaction involving an account is performed in order to obtain goods or services via a website of commercial server 206, a user of client device 204 enters account information related to an account to provide payment to the commercial server 204. The account information is generally in the form of an account number (made up of numerals, letters, alphanumeric characters, or symbols) and may correspond to a payment card number, i.e., a credit card number or a debit card number. The account information then may be transmitted to the financial processors 208, or a merchant bank 210, or a financial services company 212. The account is typically managed by a financial services company or a merchant bank. Along the way, each entity may retain a portion of the payment as compensation for their services or to protect itself against a fraudulent user of the account. Thus, it is important to provide mechanisms to help verify that a user of the account is properly authorized. Indeed, the more certain that the financial services company or merchant bank is that the user of the account is authorized, the less need there is for intermediate financial processors.

In accordance with the present invention, methods are used to facilitate secure payment for digital transactions by verifying, for example, by using account-independent information, that a user of an account in a digital or online transaction is authorized. An authorized user may be required to log in to an application located on client device 204 or log on to a website of either the merchant bank 210 or the financial services company 212 that controls or manages the account. Upon successfully logging in, the authorized user may access the website of the commercial server 206 in order to perform a digital transaction.

Another method associates an account represented by payment card 202 with an authorized user's client device 204 via an application forwarded from either financial services company 212 or merchant bank 210. The application used to associate payment card 202 with the client device 204 may be, for example, electronic, implemented in software or firmware, or it may be implemented in hardware, such as a USB device. The application may be forwarded to the client device 204 electronically via the Internet or another network. The application may be provided to the financial services company 212 or to the merchant bank 210 via a third party, electronically, through, for example, electronic mail (e-mail), the third party's website, or the third party may forward the application directly to the client device 204.

An authorized user of the payment card 202 uses the application to associate the client device 204 with the payment card 202. The association via the application may involve the use of, for example, digital certificates, pairwise keys, a collection of data from the client device 204, cookies set on the client device 204, token information stored on the client device 204, or other identifying features, such as, for example, a serial number of client device 204 provided to the financial services company 212 or merchant bank 210.

The association of the client device 204 with the authorized user may also be via a physical component needed to activate the client device 204 for use of the client device 204 such as, for example, a fingerprint or a biometric scan of the authorized user, a micro-chip embedded within the authorized user, or another item external to the authorized user but required to activate operation of the client device 204.

Once the association of the client device 204 with the payment card 202 is complete, the financial services company 212 or merchant bank 210 may verify that an online transaction involving the payment card 202 originated from the associated client device 204. The verification may entail the use of, for example, digital certificates, pairwise keys, data collected from the client device 204, receipt of a cookie from the client device 204, receipt of stored token information from the client device 204, or receipt of other identifying features of client device 204 from the client device 204.

In accordance with various embodiments, the identity of the authorized user of the payment card 202 may be used to verify authenticity of a transaction involving the payment card 202. This may be in addition to or in lieu of one or more of the previously described procedures. If an online transaction involving the payment card 202 is received by the financial services company 212 or the merchant bank 210, an “out-of-band” verification of the user of the payment card 202 may be performed, such as a short message service (SMS) message to the authorized user's cell phone, or a phone call. The phone call or SMS message may involve asking the authorized user to confirm use of the payment card 202 for an online transaction. Security questions or a password may be employed to verify that use of the payment card 202 is indeed authorized. Alternatively, or in addition, an “in-band” type of verification may be used, in which an e-mail message is sent to the authorized client device 204 associated with the payment card 202 to verify that an authorized user is engaged in a transaction from the associated client device 204. In-band verification may also employ security questions or a password.

Because many people perform digital transactions from multiple client devices 204, a preferred embodiment allows for associating additional client devices 204 with a common payment card 202. This association may be made via an application from a financial services company 212 or a merchant bank 210 as previously described. The association of additional client devices could also be made by a currently authorized client device 204 informing the financial services company 212 or merchant bank 210 to add the additional client device 204 to the payment card 202. A password may be forwarded, for example, to a known client device 204, a new client device 204, or the authorized user's cell phone. The password may then be used to associate a new client device 204 with the payment card 202. Additionally, the financial services company 212 or merchant bank 210 may provide a window of time during which the new client device 204 may perform an online transaction. Once the transaction reaches the financial services company 212 or the merchant bank 210, the appropriate entity may then associate the new client device 204 with the payment card 202. However, if desired, the number of associations may be restricted to one i.e., each payment card 202 may only be associated with only one client device 204.

The disclosed systems and methods facilitate verification of an authorized user of a payment card or an account 202 in online transactions. The transaction may be forwarded from the client device 204 to the commercial server 206 in order to pay for goods or services ordered via the web site of the commercial server 206. The transaction may then be transmitted through one or more financial processors 208 to merchant bank 210, from which it may then be forwarded to financial services company 212. Either the merchant bank 210 or the financial services company 212, or both, may verify that the transaction did indeed originate from an authorized user associated with the payment card or account 202, thereby indicating that there is a strong likelihood that the transaction involving the payment card 202 was performed by an authorized user of the payment card 202. As previously noted, such verification may be performed in-band or out-of-band.

Thus, the present invention facilitates authentication of digital transactions, such as on line transactions. As a result of this facilitation, the transaction may simply be forwarded through one financial processor, or even sent directly from the commercial server to the merchant bank or to the financial services company, without the need for an intermediate financial processor.

Although certain embodiments have been illustrated and described herein, those of ordinary skill in the art will appreciate that a wide variety of alternate or equivalent embodiments or implementations intended to achieve the same purposes may be substituted for the embodiments illustrated and described without departing from the scope of the present invention. Those with skill in the art may readily appreciate that embodiments in accordance with the present invention may be implemented in many different ways. This application is intended to cover any adaptations or variations of the embodiments discussed herein. Therefore, it is manifestly intended that embodiments in accordance with the present invention be limited only by the claims and the equivalents thereof.

1. A method of facilitating secure payment for digital transactions over a computer network, comprising the steps of:
associating an account with account-independent information representative of an authorized user of the account;
identifying a digital transaction involving the account that has been initiated over the computer network; and
verifying electronically, based on the association, that the authorized user initiated the digital transaction involving the account.

2. The method of claim 1, wherein the account is represented by a payment card.

3. The method of claim 1, wherein associating the account with an authorized user is accomplished by use of an application implemented in software, firmware, or hardware.

4. The method of claim 3, wherein the application requires a successful log-in initiated by the authorized user.

5. The method of claim 3, wherein the application creates an association of the account with a client device.

6. The method of claim 3, wherein the application is provided by a third party.

7. The method of claim 5, wherein the application creates an association of a client device with the authorized user.

8. The method of claim 7, wherein the verifying step includes receiving identifying features of the client device, conveyed by at least one of a digital certificate, a pairwise key, a data set, a cookie, or a token.

9. The method of claim 7, wherein verifying entails using an out-of-band process to confirm that the account is associated with the client device.

10. The method of claim 7, wherein multiple client devices are associated with the account.
